(19) United States
(12) Patent Application Publication
(10) Pub. No.: US 2013/0144642 A1
(43) Pub. Date: Jun. 6, 2013

(54) Method of Predicting Healthcare Costs

(71) Applicant: Russell W. Bessette, Prespect, KY (US)

(72) Inventor: Russell W. Bessette, Prespect, KY (US)

(21) Appl. No.: 13/488,371

(22) Filed: Jun. 4, 2012

Related U.S. Application Data
(60) Provisional application No. 61/492,407, filed on Jun. 2, 2011.
(60) Provisional application No. 61/522,761, filed on Aug. 12, 2011.

(51) Int. Cl. G06F 19/00; G06Q 50/22

(52) U.S. Cl. CPC G06F 19/327; G06Q 50/22
USPC 705/2

(57) ABSTRACT

Computer-based methods and systems are presented for determining an illness complexity score, which can be used to predict the likelihood of high-cost hospitalization and/or to predict the patient's healthcare reimbursement costs. The methods comprise the steps of measuring a plurality of factors of a population of individuals, determining an effect on the healthcare costs of the individuals and a weighting coefficient for each factor, identifying significant factors as complexity variables, and computing illness complexity scores for the population of individuals using the weighting coefficients and complexity variables. The population data may then be used to predict the healthcare costs of a patient by calculating the illness complexity score of the individual.

### CROSS-REFERENCE TO RELATED APPLICATIONS

The present application claims the benefit of the earlier filing date of U.S. Provisional Patent Application No. 61/492,407, filed Jun. 2, 2011, now pending, and U.S. Provisional Patent Application No. 61/522,761, filed Aug. 12, 2011, now pending, the disclosures of both are incorporated herein by this reference.

### FIELD OF THE INVENTION

The present invention provides a method of predicting the healthcare costs of an individual and the likelihood of high-cost hospitalization of the individual.

### BACKGROUND OF THE INVENTION

Many policy makers have suggested that the “Quality of healthcare can be precisely defined and measured with a degree of scientific accuracy comparable to most measures used in clinical practice.” (Chassin M, Galvin R: The urgent need to improve health care quality: Institute of Medicine National Roundtable on Health Care Quality. JAMA 280: 1000-1005, 1998.) In 1994, the Institute of Medicine supported that view and added that the “Quality of care is the degree to which health services for individuals and populations increase the likelihood of desired health outcomes and are consistent with current professional knowledge.” (Council of the Institute of Medicine. America's Health in Transition: Protecting and Improving Quality. Washington, D.C.: National Academy Press; 1994.)

However despite these expectations, along with federal and state investments to transition patient medical records to an all-electronic system, a chasm still exists between healthcare quality and payment for it. Petersen et al. in an extensive review of the literature compared various methods to improve quality through pay-for-performance programs. (Petersen L, Woodard L, Urech T, et al.: Does pay-for-performance improve the quality of health care? Ann Intern Med 145:265-272 2006.) Their analysis concluded that most financial incentives were focused on the delivery of prevention services rather than health outcomes. Other investigators reported that so-called pay-for-performance programs impact some patients negatively, particularly those with mental illness and chemical dependency. (Shen Y: Selection incentives in a performance-based contracting system. Health Serv. Res. 38:535-552 2003; Norton E: Incentive regulation of nursing homes. J. Health Econ. 11:105-128 1992; Rosenthal M, Frank R, Li Z, et al: Early experience with pay-for-performance: from concept to practice. JAMA. 294:1788-1793 2005.) Such conclusions support the analysis of Porter, Teisberg, and others that American healthcare competes on delivery of the lowest procedure price rather than a value-based outcome for individual patients. (Porter M, Teisberg E: Redefining Healthcare. Harvard Business Press, ISBN 1-59139-778-2, 2006; Baker L: Measuring competition in health care markets. Health Serv. Res. 36: 223-251, 2001; Scanlon D, Swaminathan S, Lee W, et al.: Does competition improve health care quality? Health Serv. Res. 43: 1931-1951 2008.)

In order to measure treatment outcomes and compensate providers fairly, improved measuring tools are necessary. Currently, most payers score quality care based on delivery of services focused in prevention such as: up-to-date immunizations, early diagnostic studies such as mammography, colonoscopy, PAP smears, PSA testing, or education in healthy life styles. (Landon B, Zaslavsky A, Beaulieu J, et al.: Health plan characteristics and consumers' assessments of quality. Health Affairs 20: 274-286, 2001; Scanlon D, Darby C, Rolph E, et al.: The role of performance measures for improving quality in managed care organizations. Health Serv Res. 36: 619-641, 2001.) Though these services are valuable; patients still develop chronic illnesses that require treatment or palliative care. Indeed, such conditions consume the bulk of healthcare budgets. In order to grade treatment outcomes fairly, each patient should be scored as to their level of illness complexity prior to the start of treatment, so that outcomes are judged among patients of similar severity.

Currently, disease “staging” is a prime method for relating disease severity to reimbursement levels. Chronic kidney disease (“CKD”) typifies such a condition with five stages of severity based on a declining glomerular filtration rate. However, many of these patients are at risk for higher complexity due to co-morbid factors like hypertension, diabetes, and congestive heart failure. Unfortunately, payers may have incomplete information about the severity of these co-existing morbidities, and therefore must rely primarily on CKD staging to evaluate quality care. Payment by stage of illness also provides a convenient method to aggregate cost and grade treatment upon the overall public health. (Johnson C, Levey A, Coresh J, et al.: Clinical practice guidelines for chronic kidney disease in adults: Part 1. Definition, disease stages, evaluation, treatment, and risk factors. American Family Physician 70: 869-876, 2004; Smith D, Gullion C, Nichols G, et al.: Cost of medical care for chronic kidney disease and comorbidity among enrollees in a large HMO population. J. Amer Soc Nephrology 15: 1300-1306, 2004.) Unfortunately, clinical experience suggests that these ordinal measures for renal disease, though ideal for population reports, do not fully account for illness complexity seen in individual patients. When pay-for-performance is linked to grading of illness by stage, it may imply quality on a population basis, however, if the true level of illness complexity at the start of treatment is unknown, then the value of any outcome compared to the cost in achieving it, also remains unknown. (Born P, Simon C.: Patients and profits: the relationship between HMO financial performance and quality of care. Health Affairs 20: 167-174, 2001; Kessler D, Geppert J.: The effects of competition on variation in the quality and cost of medical care. Jour of Economics and Management Strategy 14: 575-589, 2005; McGlynn E, Asch S, Adams J, et al.: The quality of health care delivered to adults in the United States. New England Journal of Medicine 348: 2635-2645, 2003.)

With the introduction of Accountable Care Organizations (“ACO”) in the United States, there is a new focus on provider compensation. Under this system, providers are encouraged to enter into risk adjusted capitation agreements within a patient centered medical home. Under this system, determining risk on small patient groups could prove difficult and compel both payers and providers to accept reimbursement based on population averages not reflecting unique features within different ethnic and geographic regions.

Patients with chronic kidney disease (CKD) are at risk for complications requiring costly hospital care. Cardiovascular disease (CVD) is a well-documented co-morbidity that drives many of those costs. [1, 2, 3] In addition, CKD patients often display dysfunction of the hematopoietic and endocrine systems that trigger mineral metabolism disorders. These abnormalities distort the balance between calcium, phosphate and parathyroid hormone leading to calcification of the arterial tree further aggravating hypertension and CVD. [4-6]

With the discovery of parathyroid hormone (PTH) receptors in the heart, some investigators have suggested that serum PTH levels are predictive for adverse cardiovascular events. [7, 8, 9] Numerous animal studies have shown increased cardiac contractility, myocardial hypertrophy, and interstitial fibrosis secondary to elevated levels of PTH.[10, 11, 12, 13] Further, it is suggested that high levels of PTH contribute to hyperlipedemia and impaired glucose tolerance.[14, 15, 16, 17]

In a comprehensive review of the literature from 1980 to 2007, Covic et al reported a significant rise in all-cause mortality, and in particular CVD events associated with serum mineral disturbances. [18] Their review supported the conclusion that abnormal plasma levels of phosphorus, followed by calcium and parathyroid hormone were associated with a greater mortality risk. However, as those authors cautioned, the majority of articles reported on patients with end stage renal disease (ESRD). A subsequent study by Bhuriya et al analyzed PTH levels in patients with CVD and stage 3 and 4 CKD. [19] Employing the PTH target ranges recommended by the National Kidney Foundation Disease Outcomes Quality Initiative (KDOQI), they utilized multivariable logistic regression analysis to report on the association of age, hemoglobin level, eGFR, plasma PTH, phosphorus, and calcium levels with CVD events. Their analysis demonstrated that PTH levels greater than 70 pg/ml increased the risk for CVD significantly. On the other hand, they found no relationship with levels of serum phosphorus or calcium.

Other investigators have reported a significant relationship with abnormal levels of alkaline phosphatase in CKD patients. [20] Their study demonstrated that elevated alkaline phosphatase predicted mortality and hospitalization in hemodialysis patients independent of calcium, phosphorus, and PTH levels.

Serum albumin is another factor advocated as a predictor of increased morbidity in CKD patients. Protein energy malnutrition and inflammation are common problems associated with end-stage renal disease. Because of its association with atherosclerotic heart disease, this condition has been referred to as “malnutrition inflammation atherosclerosis”. [21, 22] Since low serum albumin is frequently associated with this condition, it has been suggested as a predictor for increased mortality in CKD patients. [23]

In summary, chronic kidney disease is clearly associated with multiple organ dysfunctions that impact cost, diminish health and work productivity. [24-29] However as seen in the literature, there is disagreement as to which blood chemistry values reliably predict advancing illness and high cost healthcare. It is estimated that CKD afflicts up to 20 million Americans and accounts for annual dialysis costs of $121,000 per patient with ESRD. With the advent of Accountable Care Organizations (ACO's) in the United States, the ability to predict high-cost care for managing chronic disease is vital in order to create risk adjusted capitation agreements with providers. If serum chemistry values can objectively add additional information to the standard classification of CKD by ordinal stages, then their measurement may enhance public health and improve payment for healthcare services. Controversy exists in predicting costly hospitalization in patients with chronic kidney disease and co-morbid conditions, but if a method can be developed it would enabled the prediction and reduction of healthcare cost.

There is a need for a method of generating an illness complexity score relating blood chemistry values and other factors to reimbursement.

### BRIEF SUMMARY OF THE INVENTION

Computer-based methods and systems are presented for determining an illness complexity score, which can be used to predict the likelihood of high-cost hospitalization and/or to predict the patient's healthcare reimbursement costs. The methods comprise the steps of measuring a plurality of factors of a population of individuals, determining an effect on the healthcare costs of the individuals and a weighting coefficient for each factor, identifying significant factors as complexity variables, and computing illness complexity scores for the population of individuals using the weighting coefficients and complexity variables. The population data may then be used to predict the healthcare costs of a patient by calculating the illness complexity score of the individual.

### DESCRIPTION OF THE DRAWINGS

For a fuller understanding of the nature and objects of the invention, reference should be made to the following detailed description taken in conjunction with the accompanying drawings, in which:

FIG. 1 is a stacked histogram comparing average annual total per patient healthcare payments in the high-cost hospitalization and non-high-cost hospitalization groups;

FIG. 2 is a probability curve for patients with hospital care hosts exceeding $3,000 monthly;

FIG. 3 is a probability curve for high-cost hospitalization versus the Beta-weighted sum of the Z-scores of age and select blood chemistry values;

FIG. 4 is a receiver operating curve for parathyroid hormone, phosphate, and serum albumin versus high-cost hospitalization;

FIG. 5 is a receiver operating curve for high-cost hospitalization versus chronic kidney disease stage;

FIG. 6 is a scatter plot of illness complexity score (x-axis) derived as the predicted value from the linear regression for age, chronic kidney disease stage, serum phosphorus, hemoglobin, albumin, creatinine, alanine aminotransferase, white blood cells, and estimated glomerular filtration rate versus the natural logarithm of average monthly reimbursement (y-axis) for total healthcare services in 177 chronic kidney disease patients over one year;

FIG. 7 is a scatter plot of the linear predictor for average chronic kidney disease stage (x-axis) versus the natural logarithm for average monthly reimbursement (y-axis) for all healthcare services in 177 patients.

FIG. 8 is a line graph for 29 chronic kidney disease patients classified as chronic kidney disease stage 3-A (x-axis), where the y-axis scales both the average illness complexity score for each patient and the natural logarithm for average monthly reimbursements for all delivered medical services (solid line is the illness complexity score for each patient, while the dashed line is the natural logarithm for the average monthly payments made for each patient);

FIG. 9 is a graph showing the distribution of total illness complexity scores for patients within each stage of chronic kidney disease, where the starting stages of chronic kidney disease are displayed on the x-axis, and the average total illness complexity scores during the study period are shown on the y-axis;

FIG. 10 is a histogram for change in complexity scores and reimbursement over the entire study period;

FIG. 11 is a histogram for change in CKD stage and reimbursement over the entire study period;

FIG. 12 is a line graph for 177 renal patients (x-axis) depicting each patient's average illness complexity score (line with diamond-shaped points) along with each patient's respective natural logarithm for average monthly reimbursement (line with square-shaped points);

FIG. 13 is a line graph for 30 renal patients (x-axis) with an average chronic kidney disease stage that ended worse than their starting stage; and

FIG. 14 is a flowchart of a method according to an embodiment of the present invention.

### DESCRIPTION OF THE INVENTION

The present invention may be embodied as a method for determining an Illness Complexity Score (“ICS”) for a particular illness (disease, disorder). Illness or disease is defined as a condition of a living animal or plant that impairs normal functioning and is recognized by distinguishing signs and symptoms. These distinguishing signs and symptoms (factors) are confirmed by objective measurements or tests, which may include among others, blood chemistry values, physiologic function studies, genetic profiles, and diagnostic imaging.

When any test value deviates from its normal range, (that is: the range generally observed in a healthy population), then that test value alone, or as part of a group of associated test values, confirms a specific disease or illness. The degree by which a test value deviates from its normal range is significant—the greater the deviation away from normal, (above or below normal) the greater the severity of disease.

If the total pool for all diagnostic Tests (T) known to the healthcare profession are represented by Tₓ, and if all Diseases (D) known to the healthcare profession are represented by Dₙ, then any specific Disease and its confirming Tests can be represented as D=Tₓ or Dₙ=Tₓ_{ₙ} where xₙ represents the number of specific tests required to confirm a specific Disease within the array Dₙ.

Some individuals can have more than one disease simultaneously. This condition is referred to as co-morbidity. Certain illnesses commonly occur together, for example, Chronic Kidney Disease (“CKD”) has both diabetes and congestive heart failure (“CHF”) occurring with it routinely. The representation of multiple diseases and their required confirming tests could be represented by:

D₁+D₂+D₃=Tₓ_{₁}+Tₓ_{₂}+Tₓ_{₃},

where D₁ might stand for CKD, D₂ might stand for Diabetes, D₃ might stand for CHF. The specific confirming tests necessary to confirm each of those diseases are represented by: Tₓ_{₁}, Tₓ_{₂}, and Tₓ_{₃}, respectively.

The confirming tests for any disease are chosen from the peer reviewed literature, and may grow over time. For example as science progresses, genetic testing is expected to become routine. Those new tests would be added to the overall array Tₓ_{ₙ}. It is understood that any single test may be found in more than one array for a specific disease. For example, high blood pressure is confirming for both kidney disease and heart disease. It is the combination and weight factor given to each test that is unique to this diagnostic illness complexity scoring.

After selection of all confirming tests for any given illness, the next step requires converting each patient's test results into “Z-scores” based on the normal range of values for a healthy population within each laboratory where the test result was performed. (This is necessary to compare tests performed at different laboratories with different ranges for normal).

Next a linear regression calculation is performed on a population of patients with the confirmed diagnosis for the selected disease or syndrome of diseases along with the total weekly/monthly or yearly paid claims for all healthcare expenses spent on caring for each patient. This linear regression calculation will generate a series of Beta coefficients and a significance value (P value) for each separate test.

Next a backward selection process is performed in order to identify the most parsimonious series of tests that are most predictive for required reimbursement dollars. For example, if 23 different tests are part of a routine physical examination, and are associated with monitoring the health of a kidney patient with co-morbidities of diabetes, CHF, hypertension, liver disease, and infection, then which of those tests are most significant in predicting the cost of care in that patient? And of those most significant tests, what weighting factors should be given to each test? Is it worse and therefore more costly to have an abnormal liver value or an abnormal kidney value? The Beta coefficient for each variable represents that weighting factor.

Knowing the Beta coefficient (B) for each variable (each test) permits calculation of an ICS based on individual patient test values in the following manner

$$\begin{matrix}ICS = {D}_{1} ( {T}_{{x}_{1}} ) \times {B}_{{x}_{1}} + {D}_{2} ( {T}_{{x}_{2}} ) \times {B}_{{x}_{2}} + {D}_{3} ( {T}_{{x}_{3}} ) \times {B}_{{x}_{3}} \\ = {\sum }_{n = 1}^{3} {D}_{n} ( {T}_{{x}_{n}} ) \times {B}_{{x}_{n}}\end{matrix}$$

The ICS is calculated for each patient as the sum of the series for each disease (D) obtained by multiplying the Z-score for each test result by the Beta coefficient for that test.

The summed value represents the level of illness severity determined by all weighted test values which were abnormal. An ICS of 0 would mean that all tests results for a patient suspected of having disease 1 to 3 were normal, since all tests results had a value identical to the mean reference range. Higher scores represent increasing severity of illness.

Plotting the ICS against the natural logarithm for monthly/yearly dollars expended to care for each patient permits comparison of similarly ill patients against dollars expended. In this manner, objective data supports the association between levels of health and dollars to achieve a medical treatment outcome over time.

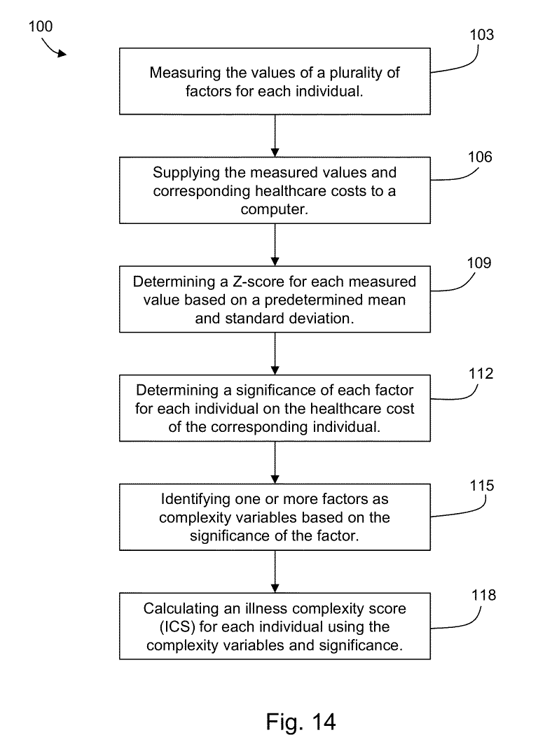

The present invention may be embodied as a method 100 of determining complexity factors for an illness based on a set of individuals having the illness (see, e.g., FIG. 14). The method comprises the step of measuring 103 the values of a plurality of factors indicative of different health parameters for each individual. The measured 103 factors may be confirming tests of the primary illness, disease, or disorder. The measured 103 factors may include factors related to co-morbidity. The measured values are supplied 106 to a computer along with the healthcare costs of the corresponding individuals (i.e., measured values match to healthcare costs for each individual).

The computer is caused 109 to calculate a Z-score for each measured value. The Z-score is calculated using the mean and standard deviation of a set of data. As a skilled person will recognize, the Z-scores may be calculated by subtracting the mean from the measured value and dividing the result by the standard deviation. The mean may be selected as, for example, the midpoint of the “normal” range for the corresponding factor. The standard deviation may be selected as, for example, one-fourth of the normal range. The Z-score is commonly known in the art to show how many standard deviations a data point is from the mean.

The computer is caused 112 to determine an effect of each factor on the healthcare cost using the Z-scores. This effect may be represented as a Beta coefficient. The determination of effect may be accomplished using regression analysis, such as a linear regression. As such, a P value may also be determined for each factor. The computer is caused 115 to identify one or more factors as complexity variables based on a significance of each factor on the healthcare cost.

The method 100 comprises the step of causing 118 the computer to calculate an illness complexity score for each individual using the complexity variables and the determined Beta coefficient corresponding to each complexity variable. The illness complexity scores may be calculated, for example, using the complexity variables (CVₙ) and the determined Beta coefficients (B_{CV}_{ₙ}) according to the equation: ICS=Σ₁ⁿ(CVₙ)(B_{CV}_{ₙ}), where n is the number of complexity variables.

The method 100 may further comprise the step of causing the computer to associate the calculated ICS for each individual of the set of individuals with the healthcare cost for the corresponding individual.

The computer may calculate an ICS for a patient having the illness using the complexity variables and the determined Beta coefficient corresponding to each complexity variable. The computer may predict a healthcare cost of the patient using the calculated ICS of the patient and the associated ICS and healthcare costs of the set of individuals. In another embodiment, the computer may predict the likelihood of high-cost hospitalization for the patient using the calculated ICS of the patient and the associated ICS and healthcare costs of the set of individuals.

The present invention may be implemented in a computer system such that a processor is programmed to perform each of the aforementioned steps. For example, a processor may be programmed to convert each patient's tests to Z-scores, perform a linear regression calculation to generate a series of Beta coefficients and a significance value (P value) for each separate test, and perform a backward selection process to identify the most parsimonious series of tests that are most predictive for required reimbursement dollars. A processor may be programmed to calculate an ICS. The present invention may be a tangible computer-readable medium embodying computer instructions for performing any of the disclosed methods.

The present invention may be implemented as a computer system for predicting healthcare costs and/or a computer system for predicting the likelihood of high-cost hospitalization. A computer may have stored thereon, the predetermined ICS and healthcare costs of a set of individuals, and the predetermined Beta coefficients and complexity variables (e.g., the formula necessary for calculating an ICS). As such, the computer system may be configured to receive a set of measured values of health factors of a patient. The system is programmed to calculate the ICS of the patient based on the predetermined coefficients and complexity variables. The ICS and healthcare costs may then be used, along with the predetermined ICS and healthcare cost data of the set of individuals, to predict the likelihood of high-cost hospitalization of the patient and/or the healthcare reimbursement costs of the patient.

The present invention is shown in additional embodiments and/or further detail through the following examples. While these examples are focused on CKD patients, it is intended to be exemplary and non-limiting, and the above methods are not limited to only CKD.

First Exemplary Study

We tested associations between serum chemistry values and the occurrence of in-patient hospital costs over a thirteen month study period. Secondarily, we derived a linear combination of variables to estimate probability of such occurrences in any patient. We calculated parsimonious values for select variables associated with in-patient hospitalization and compared sensitivity and specificity of these models to ordinal staging of renal disease. Data from 1104 de-identified patients which included 18 blood chemistry observations along with complete claims data for all medical expenses. We employed multivariable logistic regression for serum chemistry values significantly associated with in-patient hospital costs exceeding $3,000 in any single month and contrasted those results to other models by ROC area curves. The linear combination of weighted Z-scores for parathyroid hormone, phosphorus, and albumin correlated with in-patient hospital care at P<0.005. ROC curves derived from weighted variables of age, eGFR, hemoglobin, albumin, creatinine, and alanine aminotransferase demonstrated significance over models based on non-weighted Z-scores for those same variables or CKD stage alone. In contrast, the linear combination of weighted PTH, PO4 and albumin demonstrated better prediction, but not significance over non-weighted Z-scores for PTH alone.

The objective of the methods described here was to investigate the relationship between select serum chemistry values and the occurrence of in-patient hospital payments exceeding $3,000 in any single month for a range of CKD patients. Next, we compared those results to other predictive models based on non-weighted Z-scores of the same serum values or to ordinal stages of CKD in the same patients.

Our data set included 1104 de-identified patients from the kidney disease registry of a local managed care organization (MCO), who had received treatment from November 2007 through November 2008. We then excluded from this dataset 216 patients for whom there was no calculated eGFR at or below 60 ml/min repeated within 3 months, since these patients may have had acute renal disease not the focus of this study.

A total of eighteen blood tests were requested from the MCO for analysis in this study by a consulting group of university nephrologists. The test choices were made based on each variable's perceived importance in monitoring the health of CKD patients. The 18 blood tests were: serum urate, phosphorus (PO4), parathyroid hormone (PTH), glucose, glycolated hemoglobin (HbA1c), hemoglobin (HGB), bicarbonate, albumin, creatinine, urea nitrogen (BUN), potassium, calcium, sodium, alkaline phosphatase, alanine aminotransferase (ALT), bilirubin, leukocytes, and eGFR (by MDRD4). The data set also included the complete financial profile for all medical claims that were paid for these patients over the same time period. These costs were linked to lab records using SQL queries written to join lab and claims data by unique patient identifiers within each dataset and allowed reimbursements to be studied.

Since tests ordered by physicians showed marked variation in selection and repetition, we sorted the remaining pool of 888 patients into two data sets for two separate sets of modeling analyses based on the following criterion: (1), 267 patients with no missing observations for serum parathyroid hormone (PTH) in order to focus on mineral metabolism disorders; and (2) 792 patients with no missing observations for serum creatinine in order to focus on serum values associated with renal function. Several models with various sets of explanatory variables were fitted using each of these data sets. Each model was fitted to the data for the subset of all patients in the respective data sets with non-missing values for every variable in the model.

The blood tests for all patients were performed by the same laboratory. Thus, the units of measurement and normal range for each test were common to all observations. Summary measures over the 13-month observation period were calculated for each lab test by averaging the tests results over all times of observation. Except for HbA1c and eGFR, the midpoint of the normal range for each test was taken as the mean, and the range divided by four as the standard deviation for a non-diseased normal population. Each lab test was standardized using this mean and standard deviation to obtain a Z-score for each variable for each patient.

Costs were totaled within each month and used, along with the codes for service provider type (e.g., hospital, surgery, internal medicine, nephrology, family medicine, pharmacy, etc.) to define cost allocation. If any single month's total payment exceeded $3,000 and those claims were primarily for in-patient hospital care, that patient's variable value was defined to be outcome 1. We chose to name this outcome as “High-Cost Hospitalization” or HCH. Other patients not meeting this criterion were assigned an outcome value of 0, or non-HCH.

The primary purpose of our study was to test the associations between a CKD patient's serum chemistry values and the occurrence of HCH in any single month over the thirteen-month study period. Secondarily, we derived a linear combination of blood tests to estimate the probability of HCH for any given patient. Next, we tested the association of a patient's CKD stage to the occurrence of HCH under the same criterion. Next the sensitivity and specificity for predicting HCH was calculated for a sequence of cut-points on each linear predictor scale by comparing predicted values of HCH to the occurrence of true positive and true negative HCH. Finally, the predictive models were compared through calculation of areas under receiver operating characteristic (ROC) curves.

Statistical Methods.

As discussed previously, some investigators conclude that measurement of PTH, phosphorus, calcium, alkaline phosphatase, albumin and eGFR predict illness severity and hospitalization in renal patients. To test for this association, we modeled the probability of HCH as a multivariable logistic function of average age, eGFR, and the Z-scores calculated from the average measures of PTH, phosphorus, bicarbonate, albumin, potassium, calcium, sodium, alkaline phosphatase and eGFR, over the 13 month period. A backward selection model building strategy was employed to derive a parsimonious model containing only significant predictors. At each step, the explanatory variable with the highest P value greater than 0.10 was deleted. If its deletion resulted in another variable that had been significant (P<0.10) previously becoming non-significant, then the deleted variable was added back into the model and the variable with the next largest P value greater than 0.10 was deleted. These steps were repeated until only significant variables (P<0.10) remained in the model.

These analyses produced a regression table with an estimated constant and regression coefficients for each explanatory variable in the final model, along with calculated P values. The Hosmer-Lemeshow Goodness-of-Fit test was calculated to test for a lack of fit of the final model. Probability curves were created relating the linear predictor (i.e., the weighted sum of predictor variables with weights that are the estimated coefficients from the logistic regression) to the probability of HCH.

The initial data set focused on analyses of mineral metabolism and contained 267 patients; the second analysis focused on 792 patients and used other available blood chemistry values. Employing the data set with 792 patients, the multivariable logistic regression model building strategy described above was employed to derive a parsimonious model containing the significant predictors for HCH from among the following variables: age and Z-scores for blood glucose, hemoglobin, bicarbonate, albumin, creatinine, urea nitrogen, potassium, calcium, sodium, alkaline phosphatase, ALT, and white blood cell count (leukocytes). As above, the goodness of fit of the final model was tested using the Hosmer-Lemeshow test.

For the logistic regressions described above, the number of observations used to fit each model was the number with non-missing values of all variables in the model. All computations were done using the Minitab package of statistical software.

We calculated the sensitivity and specificity for each model based on a series of cut-points on the linear predictor scale for the final multivariable logistic regression models. We then compared resulting predicted values to the occurrence of true positive and true false values for HCH and calculated sensitivity and specificity for each cut-point. The same calculations were made for cut-points on the linear predictor obtained from the CKD stage model for predicting HCH. Similarly, calculations were made for a series of cut-points on the linear predictors defined by the sum of non-weighted Z-scores in both the mineral metabolism and renal models for the occurrence of HCH. Lastly, ROC curves were calculated for each model along with an area under each respective curve in order to compare models for accuracy in predicting HCH. ROC curves and areas under the curves were calculated using the software application by Eng J. ROC analysis: web-based calculator for ROC curves. Baltimore: Johns Hopkins University [updated 2006 May 17.] Available from: http://www.jrocfit.org.

Results:

For the total pool of CKD patients in this study, analysis of the claims data revealed that 435 patients had at least one HCH (i.e., HCH=1) month. The remaining 453 patients had no HCH during the 13 study-months (HCH=0).

The average annual payment per patient for the group designated non-HCH (outcome 0) was $3,167 with a range of $264 to $17,197. The average monthly payment per patient in this group was $313.

In contrast, the HCH (outcome 1) group had average annual payments of $35,892 with a range of $4,276 to $314,533. Their average monthly per patient payment was $3,136.

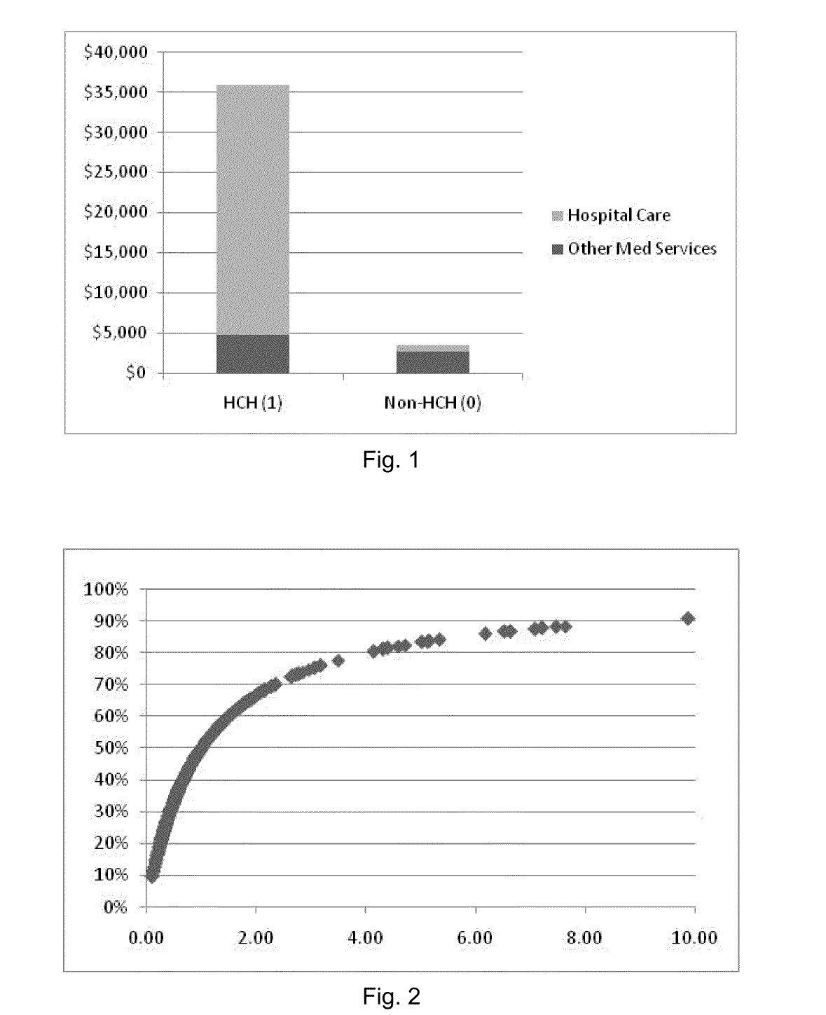

FIG. 1 is a stacked histogram demonstrating the average yearly payments per patient. Payments for hospital only services are shown in light gray, and payments for other medical services shown in black for both the HCH and non-HCH groups. In the HCH group, payments for hospital only services averaged $31,242 per patient with a range of $3,068 to $307,906. Other medical services for those same patients had average annual payments per patient of $4,671 with a range of $55 to $25,153.

On the other hand in the non-HCH (outcome 0) group, payments for hospital only services averaged $830 per patient with a range of $0 to $5,865. For other medical services, that average total payment per patient was $2,652 with a range of $264 to $16,572. See FIG. 1.

For the 267 patients with repeated PTH and serum phosphate testing, logistic regression analysis demonstrated a significant association between increasing PTH levels and HCH at P<0.005. The Hosmer-Lemeshow Goodness-of-Fit test P value was calculated at 0.06 with 66.5% concordant pairs between the response variable and the predicted probabilities.

For those variables associated in the literature with mineral metabolism disorders (age, PTH, phosphorus, bicarbonate, albumin, potassium, calcium, sodium, alkaline phosphatase, eGFR) their overall P value for correlation with HCH was significant at P<0.005, nonetheless, a number of variables had P values that were not significant. After a step-wise elimination of the least significant variable, the regression calculation for the most parsimonious model demonstrated that PTH, phosphorus and albumin had significance at P<0.005 with a Chi-Square Goodness of Fit test that was not significant (P=0.83). In addition, there was an association of 74.3% concordant pairs between the response variables and predicted probabilities.

Using the calculated regression coefficients for the linear predictor's constant and PTH, phosphate, and albumin coefficients, we calculated a probability curve for HCH as a function of the linear predictor, using the following formula for probability of HCH given elp/(1+elp), where

lp=−1.21+0.03*PTH Z-score+0.36*PO4 Z-score−0.54*albumin Z-score.

By calculating e^{lp}/(1+e^{lp}) for each patient and plotting versus the B-weighted sum of the Z-scores, we produced the curve shown in FIG. 2.

The probability for HCH increased sharply to 50% as the linear predictor for serum PTH, phosphorous and albumin increased from 0.0 to 1.0. With an increase of the linear predictor to 2.0, the probability for HCH rose to 65%. As the linear predictor increased to 4.0, the probability for HCH reached 80%. And as the linear predictor doubled from 4.0 to 8.0, the probability of HCH increased to 90%.

In order to tabulate the impact of individual variables on the outcome of HCH, we calculated individual probability curves for PTH, phosphorus and albumin. By holding each of the non-selected variables at Z-score=0, we recalculated logistic regression values and subsequent probability values. For Z-scores of PTH at 20, 40, and 70, the probability of HCH was 34%, 50%, and 72%, respectfully. For Z-scores of phosphorus at 2, 4, 6, the probability of HCH was 36%, 55%, and 70% respectively. For Z-scores of albumin at −2.0, −3.0, and −4.0, the probability of HCH was 42%, 55%, and 69% respectively.

Since the reference range for normal can vary in different laboratories, practicing clinicians can calculate the Z-scores for their patient's test values and substitute those values within the above formulas in order to calculate patient specific probabilities.

Since the data pool for renal patients with serum testing other than PTH and phosphorous was considerable larger (792), we calculated logistic regression coefficients for the variables of age, glucose, hemoglobin, bicarbonate, albumin, creatinine, BUN, potassium, calcium, sodium, alkaline phosphatase, ALT, leukocytes, eGFR and to achieve the most parsimonious model each variable with the least significant value was eliminated in a step wise fashion and the logistic regression recalculated. The final list consisted of age, hemoglobin, albumin, creatinine, ALT, and eGFR.

This calculation had P<0.005 and a Chi-Square Goodness of Fit test by the Hosmer-Lemeshow method that was not significant at the 0.40 level. In addition, the association between the response variable and the predicted probabilities had 69.9% concordant pairs.

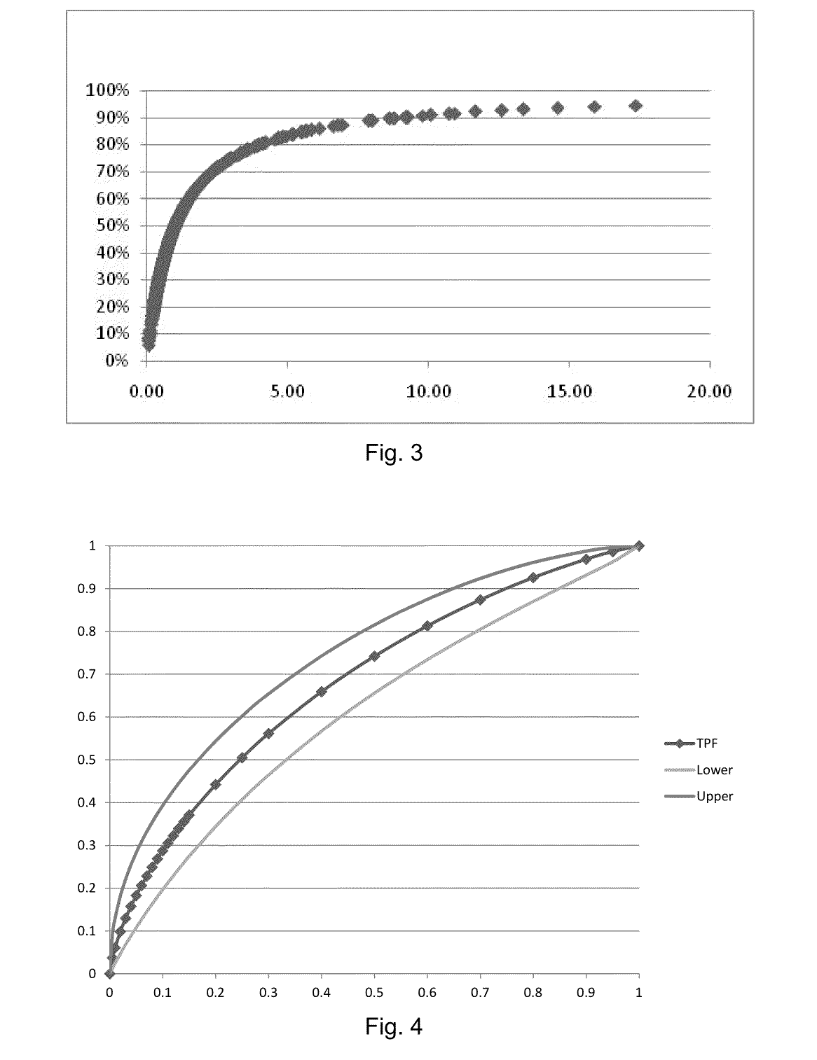

Calculation of a probability curve for the outcome of HCH over the study period versus the linear predictor for those variables is displayed in FIG. 3.

FIG. 3 illustrates the steep rise in probability for HCH to 67% as the linear predictor increased from 0.0 to 2.5. As the curve begins to plateau at a predictor value of 3.0 to 5.0, the probability of HCH increased from 67% to 82%. With an increase in predictor values from 10.0 to 17.0, the probability for HCH rose from 90% to 97%.

FIG. 4 is the ROC area curve based on a sequence of cut-points on the linear predictor defined by the weighted Z-scores of PTH, PO4, and albumin.

The Area under the Curve (AUC) shown in FIG. 4 was calculated at 0.68. This value was compared to the AUC for a model based on the sum of the non-weighted Z-scores for PTH, PO4 and albumin. The AUC for that curve was 0.64. Significance of the difference between these two curves revealed, as expected, a P value >0.05. In a similar manner, the AUC derived from the Z-score of PTH alone, as well as for stages of CKD, both had areas of 0.64.

For the cohort of 792 patients, the AUC derived from the linear combination of predictor values for age, serum hemoglobin, albumin, creatinine, ALT and eGFR compared to the true positive occurrence for HCH had an area of 0.699.

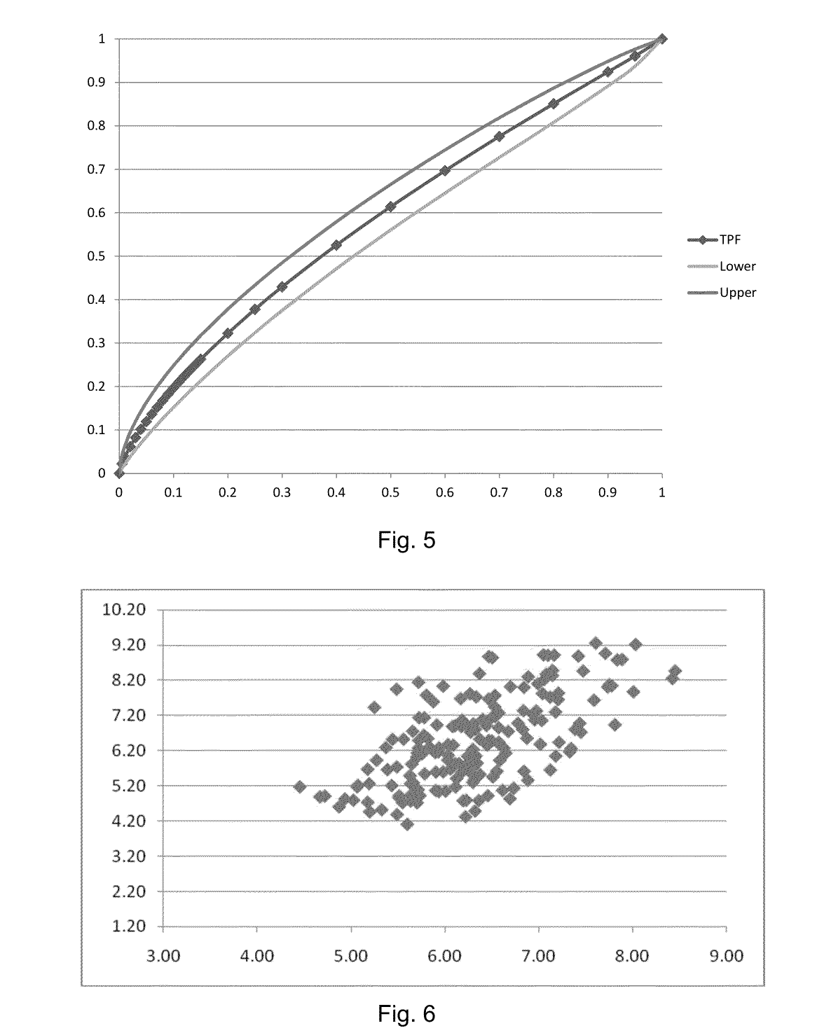

In contrast, FIG. 5 demonstrates the ROC curve comparing CKD stage to the true positive occurrence of HCH. That AUC was calculated at 0.585. The significance of the difference between the AUC shown in FIGS. 4 and 5 demonstrated significance at P<0.005.

In a similar manner, The ROC area curves based on the sum of the non-weighted Z-scores for hemoglobin, creatinine, albumin and ALT was calculated at 0.472, and when compared to AUC for FIG. 4 demonstrated significance at P<0.0005. Similarly, the AUC derived from comparison of the average eGFR to the true positive and true negative occurrence of HCH was calculated at 0.414 and when compared to FIG. 4 demonstrated a significance at P<0.0005.

Our study suggests a linear combination of select serum values correlates with prediction of in-patient hospital care (HCH) for CKD patients defined as payments in excess of $3,000 in one or more months over a one year study period.

Although there is controversy in the literature over which mineral metabolites are most significantly related to morbidity and mortality, our investigation found that the sum of a linear combination of beta weighted Z-scores for PTH, phosphorous and albumin correlated significantly with the outcome of HCH.

Given the limited pool of 267 patients with regular testing for serum parathyroid hormone and phosphorus, our findings justify further exploration of this promising relationship. Initially we questioned whether patients with tests for PTH and phosphorus had more advanced renal disease than our second cohort of 792 patients without such testing. However the average CKD stage for patients in the first and second cohorts was: 3.8 and 3.6 respectively.

The area under the ROC curve for the linear combination of weighted values for PTH, PO4 and albumin was greater, but not significantly different, than the areas under ROC curves for the non-weighted sum of Z-scores for PTH, PO4 and albumin or for the Z-score of PTH alone. The association of true positive HCH with the Z-score for PTH alone was intriguing to us. The Z-scores for average PTH within our patient pool ranged from −2.1 to 79.7, with a mean value of 5.9. This wide variation was not observed in the average Z-scores for PO4 or albumin which ranged from −3.6 to 8.1 (mean 0.9), and from −4.9 to 1.2 (mean −1.0) respectively. The wide variation for PTH and its strong correlation with HCH is consistent with other researchers. [19] But this finding is contrasted to other studies analyzing the association of single blood tests to average cost for healthcare. [30] These latter investigators concluded that deviation of single blood tests from their normal range did not predict healthcare costs. We generally agree with that conclusion, and further suggest that measurement of multiple serum variables within a related system such as mineral metabolism disorders or renal dysfunction may improve prediction modeling and correlation to cost. We plan future studies to expand our pool with no missing observations for variables associated with mineral metabolism and renal function. With greater access to data from electronic health records, we postulate that addition of physical measures such as systolic blood pressure and BMI may further improve predictive modeling.

Our second cohort of 792 patients with more complete observations and weighted Z-scores displayed better correlation to the true positive occurrence of HCH. That model differed significantly from the model based on non-weighted Z-scores of the same blood tests or for stages of CKD.

As public policy supports sizable investments in electronic health records, along with regional health information exchanges, there is rapid movement towards Accountable Care Organizations within the United States. Since ACOs intend to shift provider focus from procedure pricing to better health outcomes, the incentive for achieving this goal is financial compensation based on individual patient outcome. Such a shift will require metrics to predict expected outcomes for patients in various stages of illness. Currently most payers rely on claims data for prediction. Such analysis is population based and does not recognize individual patient complexity.

In order to tailor prevention for better health, improved disease modeling is necessary. Accurate forecasts based on objective data will also enhance delivery of value-based outcomes. We believe that further investigation is warranted to evaluate additional linear combinations of diagnostic measures for select chronic illnesses in order to achieve these goals.

In conclusion, our study demonstrates that:

1: A linear combination of blood tests based on Z-scores for PTH, PO4, and albumin derived from a multivariate logistic regression model correlates significantly with in-patient hospital payments (HCH) exceeding $3,000 in one or more months over a 13 month study period at P<0.005.

2: Summing the exponential values for the regression coefficients derived from the logistic regression for those variables divided by one plus the exponential linear progression for those same variables produced a probability curve predicting HCH.

3: Calculation of a probability curve for the occurrence of HCH in one or more months during the study period based on the linear progression of the variables for age, serum hemoglobin, albumin, creatinine, ALT and eGFR demonstrated significance at P<0.005.

4: Calculation of receiver operating characteristic (ROC) curves for the models predicting HCH based on the linear combination of age, hemoglobin, albumin, creatinine, ALT, and eGFR demonstrated significance at P<0.005 when compared to ROC area calculations for models based on the non-weighted Z-scores for those same variables or CKD stage alone.

5: In contrast, ROC area curves derived from a linear combination of values derived from weighted variables for PTH, PO4, and albumin demonstrated prediction that was better, but not significantly different, than ROC area curves calculated for the non-weighted Z-scores for those same variables as well as PTH alone.

6: Our findings suggest that multivariate logistic regression calculations based on blood chemistry values related to illness severity and reimbursement may have value to future accountable care organizations in creating risk adjusted compensation models for providers. In addition, these predictive models may have value in earlier identification of patients for targeted prevention therapy.

Second Exemplary Study

Since chronic kidney disease is often associated with multiple organ dysfunctions that impact cost, health, and work productivity, the diversity of treatment modalities required to care for these patients may lead to disagreements between providers and payers on therapy approval and reimbursement. Thus, an objective of the present invention was to formulate an illness complexity score (“ICS”) based on a linear regression of select blood values that could assist in predicting average monthly reimbursements in CKD patients. A second objective was to compare the results of this ICS prediction to results obtained by CKD prediction of average monthly reimbursement. A third objective was to analyze the relationship between the change over time in ICS and CKD stage to average monthly reimbursement. Another objective was to broaden the generation of the ICS beyond CKD.

Method:

Samples Analyzed

The data set analyzed included 1104 de-identified patients from a local managed-care-organization's (“MCO”) kidney disease registry, who had received treatment from November 2007 through November 2008. Patients without a calculated stage of kidney disease or a repeated eGFR that was at or below 60 ml/min over a three-month period were excluded (216 patients), since they may have represented acute renal disease, which was not the focus of this study. After exclusion, 888 CKD patients remained in the sample.

Variable Definitions

A total of eighteen blood tests were requested from the MCO for analysis by a consulting group of university nephrologists. The choice of tests was made based on each variable's perceived importance in monitoring the health of CKD patients. The 18 blood tests were: serum phosphorus, parathyroid hormone (“PTH”), glucose, glycolated hemoglobin (“HbA1c”), hemoglobin, bicarbonate, albumin, creatinine, blood urea nitrogen (“BUN”), potassium, calcium, sodium, alkaline phosphatase, alanine aminotransferase (“ALT”), bilirubin, leukocytes, and eGFR. The data set also included the complete financial profile for all medical claims that were paid for services for these patients over the same time period. These costs were also studied.

Since blood tests ordered by physicians showed marked variation in selection and repetition, we filtered the remaining pool of 888 patients into a data set of 177 patients with no missing values for the following fifteen tests that were repeated at least twice or more over the study period: phosphorus, PTH, glucose, hemoglobin, bicarbonate, albumin, creatinine, urea nitrogen, potassium, calcium, sodium, alkaline phosphatase, ALT, WBC (leukocytes), and eGFR. The blood tests for all patients at all times were performed by the same laboratory. Thus, the units of measurement and normal range for each test were common to all observations.

Data for each patient was organized on a spreadsheet with columns labeled for patient ID, date of medical service, payments for all reimbursed medical care, CKD stage, and results of each blood test. Rows were grouped by patient ID and chronological dates for medical services. Since all fifteen blood tests were not repeated on each date that a medical procedure was delivered, test results were carried forward to subsequent rows until replaced by a fresh test result. The average number of data rows for each patient was 13.1 with most patients having one or more tests repeated in 8 of the 13 study period months.

Next, with the exception of age and eGFR, each blood test result was converted to a Z-score as follows: the midpoint of the normal range for each test was taken as the mean, and the range divided by four as the standard deviation for a non-diseased normal population. Each lab test was standardized using this mean and standard deviation to obtain a Z-score for each variable for each patient. Next the Z-scores for each patient's test results, along with their age, eGFR, and all reimbursements in each respective column were averaged by month.

A summary spreadsheet contained 177 lines for each patient's average age, eGFR, average monthly reimbursement, and average Z-scores for all tests over the entire study period. These averaged values for all variables were utilized in a linear regression equation to develop a predictor for average monthly reimbursement in each patient. Graphs and significance levels were calculated on these results. The same regression coefficients used in the preceding equation were also employed to calculate ICS for each patient on each date of service in order to analyze change.

The change in ICS from start to end of the study period was used to cohort the population into three outcome groups: better, same, or worse. Changes in CKD stage from beginning to end of the study period was calculated directly from the laboratory values at date of service.

Statistical Methods

To test for the relationship between average blood chemistry values, stages of CKD, age, and average monthly reimbursement, we modeled that association through a linear regression function of age, eGFR, and the Z-scores calculated from average monthly values of phosphorus, PTH, glucose, hemoglobin, bicarbonate, albumin, creatinine, urea nitrogen, potassium, calcium, sodium, alkaline phosphatase, ALT, and WBC. A backward selection strategy was then employed to derive a parsimonious model containing only significant predictors. At each step, the explanatory variable with the highest P value greater than 0.10 was deleted. If its deletion resulted in another variable that had been significant (P<0.10) previously becoming non-significant, then the deleted variable was added back into the model and the variable with the next largest P value greater than 0.10 was deleted. These steps were repeated until only significant variables (P<0.10) remained in the model.

These analyses produced a regression table for the final model with an estimated intercept and regression coefficients for each explanatory variable, along with calculated P values. Next employing the regression coefficients calculated for the most parsimonious variables, these coefficients were employed in a regression equation to calculate a linear predictor by multiplying each appropriate regression coefficient with their respective averaged explanatory variable and summed. The results for each patient were plotted on a scatter plot of ICS versus the natural logarithm for each patient's average monthly reimbursement.

Next, employing the regression coefficients calculated for the most parsimonious variables, an ICS was calculated for each patient on each date of service with no missing variables. As described previously, the regression coefficients used to calculate each ICS on each date of service for each patient were derived from the linear regression calculation for the entire population based on average Z-scores for each patient. The chronological change in illness complexity scores calculated in this way throughout the study period permitted analysis of the relationship of outcome result (i.e., change in ICS) to reimbursement.

Next, the coefficients of the linear regression of the average natural logarithm for monthly reimbursements on average CKD stage categories for each patient over the entire study period were estimated. In a manner similar to developing a linear predictor for multiple blood tests above, the regression coefficient for CKD stage was multiplied with each observed indicator variable for stage and summed with the estimated intercept to produce a predicted value of reimbursement based on stage. Subsequently, these values were plotted in a scatter gram against the average natural logarithm for monthly reimbursement.

Finally, in order to evaluate the relationship between outcome and reimbursement, the study pool was sorted by change in ICS from first to last observation month and then divided into three groups: patients with a worse ending ICS, patients with the same start to end ICS, and patients with a better ending ICS. Next the study pool was sorted by change in CKD stage from start to end and divided into the same three groups based on improvement or worsening of stage. The average values for each patient's starting and ending ICS or CKD stage were evaluated by a paired T-Test, and the significance for the change in average reimbursement within each subset was evaluated by an ANOVA calculation. In order to illustrate the predictive power of complexity score as a predictor of average monthly reimbursement, average ICS and CKD stages from start to end of the study period for each patient were plotted in line graphs and compared to a similar plot for the log of average payments. In addition, R² values were calculated from the linear regressions.

Results:

Table 1 displays the coefficients and P values from the regression of the average logarithm of monthly reimbursement on the full set of variables in the table. This regression was based on the sample of 177 patients with observations on all variables analyzed. The overall R² value from the regression was 0.424 (P=0.0005).

TABLE 1

| | Variable Coefficient | P value |
|---|---|---|
| Constant | −2.84 | 0.37 |
| Age | 0.01 | 0.10 |
| Stage CKD | 1.24 | 0.03 |
| PO4 | 0.15 | 0.04 |
| PTH | 0.00 | 0.33 |
| Glu | 0.01 | 0.57 |
| Hgb | −0.33 | 0.00 |
| HCO3 | −0.03 | 0.71 |
| Albumin | −0.28 | 0.00 |
| Creat | 0.03 | 0.01 |
| BUN | 0.01 | 0.55 |
| Potassium | −0.07 | 0.33 |
| Calcium | 0.08 | 0.25 |
| Sodium | 0.06 | 0.53 |
| Alk-P | −0.01 | 0.92 |
| ALT | 0.31 | 0.00 |
| WBC | 0.17 | 0.00 |
| eGFR | 0.08 | 0.00 |

Although the overall P value for the association of these variables to average monthly cost was significant, as shown in Table 1, a number of variables had P values that were not significant. After a step-wise elimination of the least significant variable at each step, a parsimonious model was obtained and is presented in Table 2:

TABLE 2

| | Variable Coefficient | P value |
|---|---|---|
| Constant | −2.86 | 0.36 |
| Age | 0.01 | 0.09 |
| CKD Stage | 1.31 | 0.02 |
| PO4 | 0.17 | 0.01 |
| Hgb | −0.31 | 0.00 |
| Albumin | −0.25 | 0.00 |
| Creat | 0.03 | 0.00 |
| ALT | 0.30 | 0.00 |
| WBC | 0.16 | 0.00 |
| eGFR | 0.08 | 0.00 |

This parsimonious set of variables had an overall P value of 0.005, with an R² of 0.41 and an adjusted R² of 0.37.

The association between the ICS derived from this model and the average logarithm for monthly reimbursement for all healthcare services for each patient is shown in the scatter plot of FIG. 6. The average ICSs over the entire study period are displayed on the x-axis, and are derived from the intercept plus a linear predictor derived by the sum of Z-score for each test multiplied by its respective variable coefficient shown in Table 2. That is, the ICS was defined as the predicted value of the average logarithm of reimbursement. The average logarithms for monthly reimbursements for all healthcare services are displayed on the y-axis.

As shown in FIG. 1, complexity scores ranged from 4.45 to 8.45 (x-axis) and were associated with increasing average monthly reimbursements: 4.11 to 9.26, (US$61 to US$10,509) (y-axis). The R² value for the relationship between illness complexity scores and the average natural logarithm for monthly reimbursement for all healthcare services is 0.41.

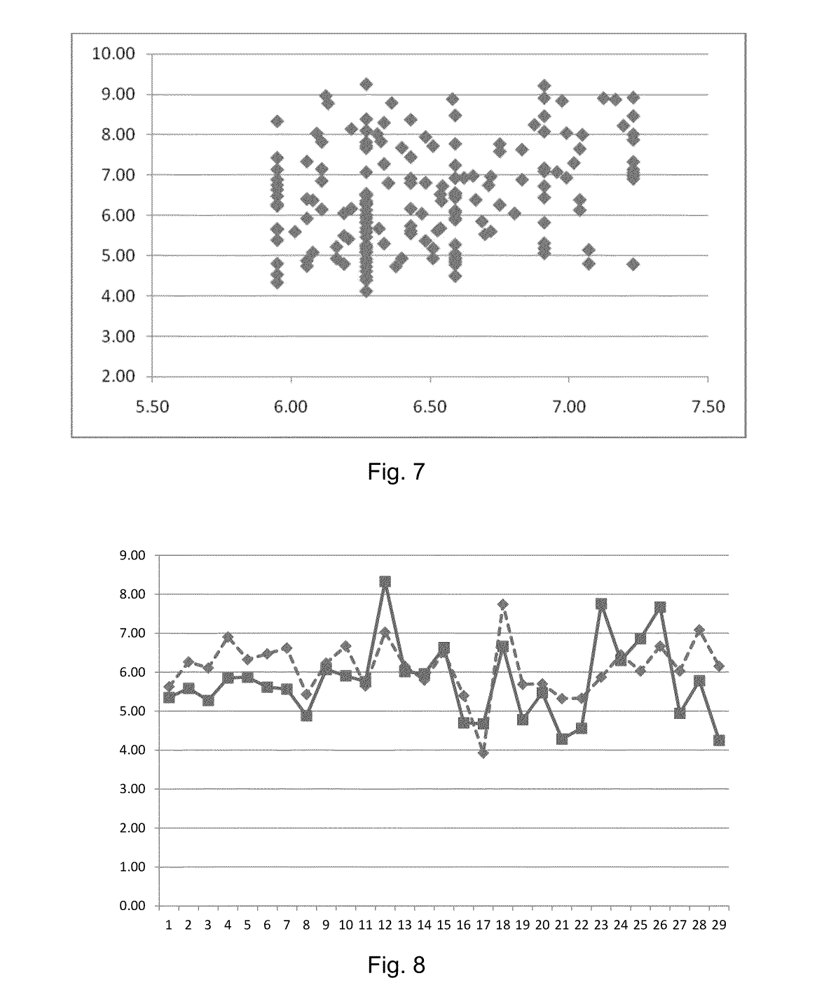

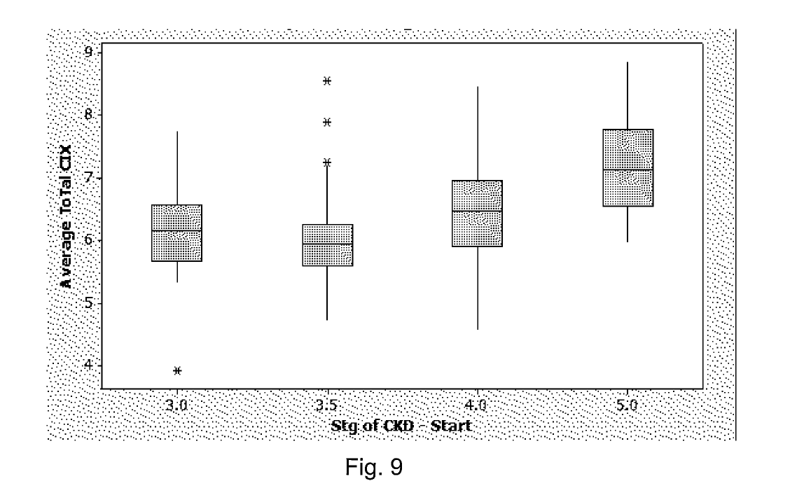

This result is contrasted to the scatter plot shown in FIG. 7 for the same CKD population, but sorted by average CKD stage for each patient over the study period. The average values for CKD stages are based on a calculated eGFR (Modification of Diet in Renal Disease 4) and weighted by their regression coefficients which are displayed on the x-axis, while the average natural logarithm for monthly reimbursement for all healthcare services is shown on the y-axis.

The variation in average monthly dollars for all four CKD stages shown in FIG. 7 varies from 4.11 to 9.26 ($61 to $10,509). Interestingly, this widest range of reimbursements was seen in the vertically aggregated diamonds seen at x-axis=6.27 which is associated with CKD Stage 3B. The linear regression for the association between average stage of CKD and average monthly reimbursement demonstrated an R² value of 0.083 with an adjusted R² of 0.078%.

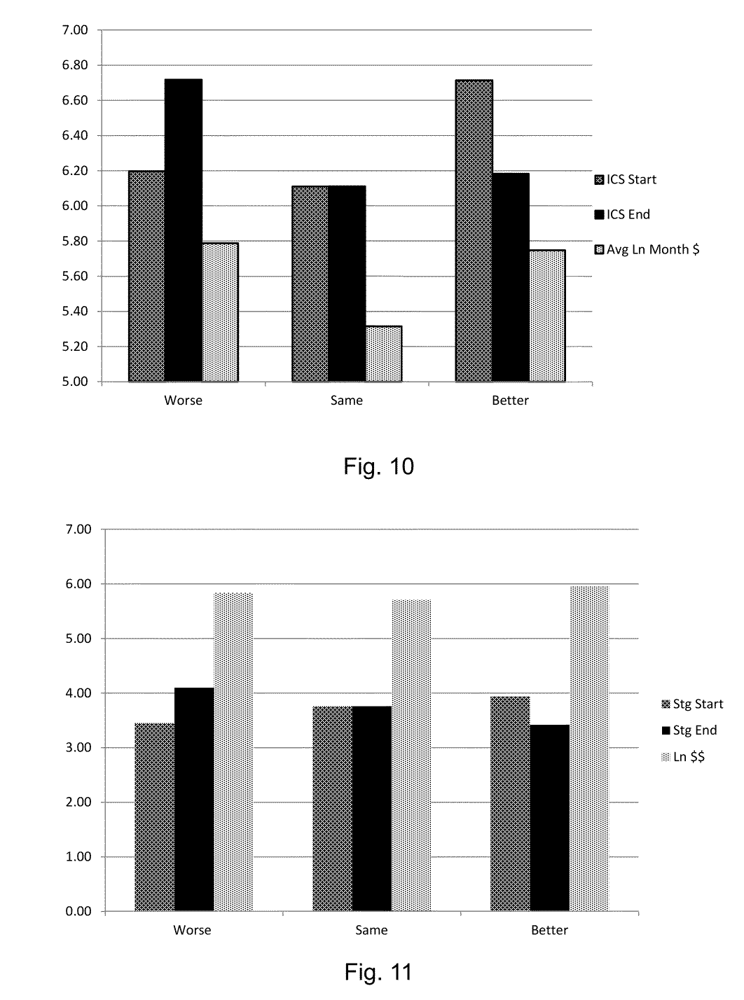

In order to evaluate changes observed in ICS and CKD stage over the entire study period and to correlate those changes to reimbursement, the patient pool was sorted by change in both ICS and CKD stage from first to last observation and compared to their respective average monthly reimbursements. These results are shown in FIGS. 10 and 11.

FIG. 10 is a histogram demonstrating the average reimbursement for all healthcare services for the patient pool sorted by worse, same or better ending ICS. The left bars in each group of bars represent average complexity scores at the start of the study period, while the right bars are average scores at the end of the study period. The center bars represent the average natural logarithm for total monthly payments.

The 86 patients with a worse ending ICS had an increase from a start of 6.20 to an ending value of 6.72. The 30 patients with no change in their ICS from start to end had an average score of 6.11. The 61 patients with illness complexity scores that improved over the study period had values that began at 6.71 and decreased to 6.18. A paired T-Test for comparison of the change from start to end demonstrated that both the worse ending and better ending cohorts had significant differences at P value=0.00.

The average monthly reimbursements for all healthcare services in each group (worse, same, or better) was 5.79 ($327), 5.32 ($204), and 5.75 ($311) respectively. A one way ANOVA calculation for differences in the average monthly reimbursement for patients with worse ending ICSs compared to patients with same starting and ending scores demonstrated significance at P value=0.05. The one-way ANOVA test for comparison of differences between average monthly reimbursements in patients with worse ending scores to those with better ending scores had a P value=0.78.

In contrast, FIG. 11 is a histogram for the same patient population, but sorted by a worse, same, or better ending CKD stage. The x-axis is the same as in the previous figure, and the y-axis displays the average value for changes in CKD stage within each group as well as the average logarithm for total monthly reimbursement.

The 30 patients with a worse ending CKD stage had an average stage change from 3.45 to 4.10. The 122 patients that remained at their same stage had an average value of 3.76. The 25 patients with an improved ending stage had a change from 3.94 to 3.42.

A paired T-Test for the change in average stage in both the worse and better ending cohorts demonstrated significance at P value=0.00. However the ANOVA calculation for the difference in average monthly reimbursement among any of the three groups revealed no significant differences between worse and same, or same and better ending, P value=0.50 and P value=0.26 respectively. The difference between same ending and better ending CKD stage was not significant at P value=0.68.

The average monthly reimbursement for all three groups of Worse, Same, or Better was 5.84 ($344), 5.71 ($302), and 5.96 ($388) respectively.

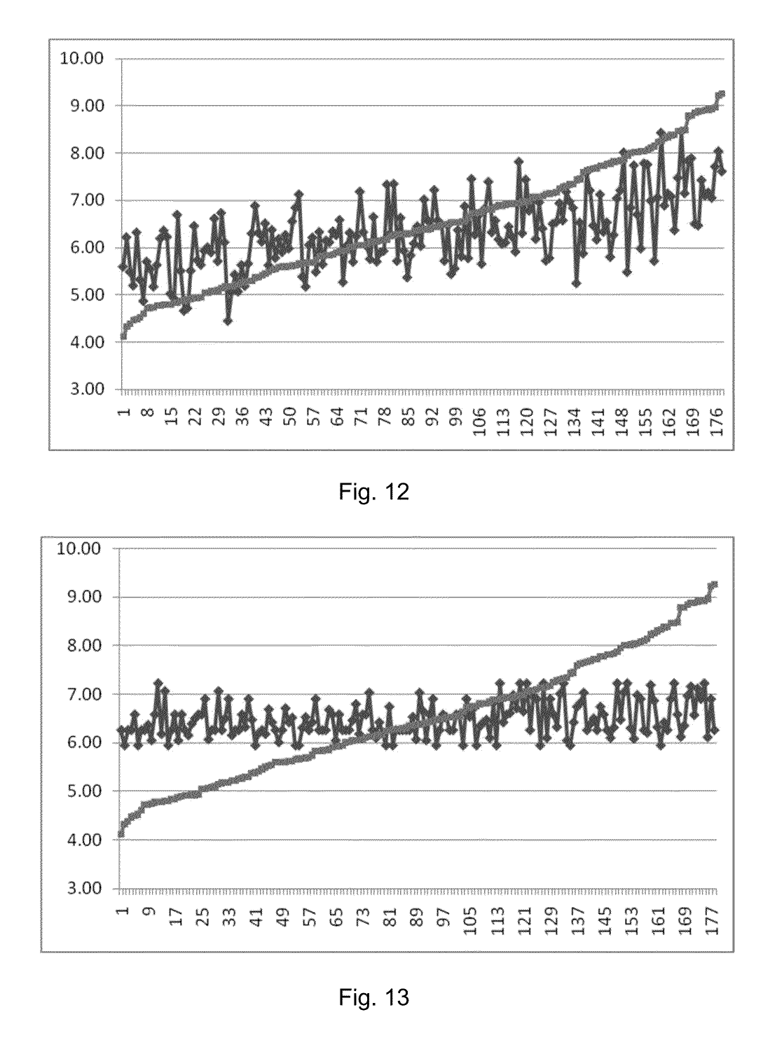

In order to compare the relationship between average ICS and average CKD stage to the average natural logarithm for monthly reimbursement in each patient, the two patient pools were rank ordered by reimbursement amount from smallest to largest and plotted by line graphs as shown in FIGS. 12 and 13.

FIG. 12 is the line graph for 177 patients displaying the relationship between ICS and the average natural logarithm for total monthly reimbursements. The irregular line (having diamond-shaped points) depicts ICS values (y-axis) for each patient displayed on the x-axis. The slightly sigmoid line illustrates the values for the natural logarithm of average monthly reimbursements for each patient (also on the y-axis scale). The linear trend for these scores was from an ICS value of 5.6 to 7.7. As suggested by the R² value of 0.41, there is correlation of the predicted ICS values to average monthly reimbursement in the mid range of the line graphs with a symmetrical divergence of ICS values at both the upper and lower regions of the graph.

In contrast, FIG. 13 demonstrates the line graph comparing average CKD stage to the average natural logarithm for monthly reimbursements in 177 patients. The linear trend line for the beta weighted average stages of CKD ranged from a value of 6.2 to 6.9 with an R² value of 0.083. The small correlation of weighted CKD stage values with the line plot for average reimbursement demonstrates this predicted relationship with wide divergence of the ICS predicted values from the average monthly reimbursements.

Discussion:

As patients, payers, and elected officials seek to improve the public health and lower healthcare costs, there is the need to understand the correlation between illness complexity, outcome and reimbursement. Recent legislation to reform healthcare and provide universal coverage mandates a shift in provider compensation to a system that rewards value-based outcomes. Generally, when payment for professional services is considered, costs are expected to parallel problem complexity, that is: the more severe the problem, the higher the expected cost. Conversely, if the problem is routine, so is the expected fee. Based on this assumption, a goal was to utilize routine blood test measures and analyze their association with predicted costs. In addition, a derivative of those measures was evaluated to score illness complexity (ICS) with a single numeric value that had a reliable relationship with reimbursement, and might offer more information about disease severity than CKD staging alone. The results of the study demonstrated that the association between average ICS values throughout the entire study period predicted average monthly reimbursements with an R² value of 0.41. Comparing that value to the association between the average CKD stage to average monthly reimbursement revealed an R² value of 0.083. Thus, the ICS offers five times greater sensitivity over CKD staging as a measure of illness complexity.

A major concern for payers, under any system, is that providers will revert to a fee-for-service concept, which incentivizes the use of more services. Without reliable, objective measuring tools to score illness complexity and outcome, both providers and payers must depend on subjective anecdotal arguments to debate disagreements on reimbursement. Without reliable data to predict likely treatment outcomes, risk-adjusted capitation agreements as part of a future ACO will pose a challenge. As a result, payers will be constrained to continue judging quality and reimbursement based primarily on claims data for any given illness. Alternatively, they may divide the claims data into deciles and pay providers within a range of chosen deciles. Such systems are population based and do not consider individual patient variation or outcome.

A measuring tool that recognizes illness complexity at the start and end of treatment in CKD patients, while still respecting the concerns of over utilization in healthcare services, can augment current metrics that base provider payment upon ordinal staging of CKD. An exemplary illness complexity score (ICS) according to the present invention is derived from the summation of the linear regression for an equation constant, patient age, and select serum chemistry values, which produced a single score based on the deviation of blood tests from their normal mean. The regression coefficients were calculated from a linear regression of average Z-scores for each blood test for each patient in the study pool versus the natural logarithm of average total monthly reimbursements for those same patients. The resultant regression coefficients were then subsequently used to weight the most significant blood test results shown in Table 2 for any patient on any single date of service. The final illness complexity score (ICS) for any given date of service was based on these weighted factors. With future access to larger data pools, with more longitudinal observations for each variable, we believe the reliability for these coefficients could be improved.

The staging of renal disease by a calculated eGFR is a gold standard for evaluating patients with kidney dysfunction. However, determining payment for healthcare services based primarily on this measure may not illuminate the impact of co-morbid conditions, or account for different outcomes influenced by additional illness complexity. Though there are many other tests, which one could employ in a CKD population, the present study was restricted to those serum chemistry values considered by the consulting nephrologists to be important in monitoring CKD patients, and importantly were often ordered by primary care physicians as part of a routine blood panel.

FIG. 6 illustrates that rising illness complexity scores are associated with increasing average monthly expenditures for healthcare services. Although there is a wide variation in cost associated with any single illness complexity score, the range for reimbursements based on ICSs ranged from 4.11 to 9.26 and represented dollar amounts of $61 to $10,509. Evaluating the range of reimbursements for patients sorted by CKD stage as shown in the linear regression weighted values in FIG. 7, their range was identical to that seen in FIGS. 6: 4.11 ($61) to 9.26 ($10,509). However, the extremes of this range was observed in two patients both classified as CKD stage 3B. Illuminating this weak association of CKD stage to reimbursement is an R² calculation with a P value=0.689.

The high ICSs, shown in FIG. 6, result from blood chemistry values that deviate markedly from their normal range. Since the selected blood tests reflect function within multiple organ systems (renal, hematopoietic, endocrine, liver, mineral metabolism, inflammatory, and cardiac), we suggest it adds additional information based on the impact of co-morbid conditions, and therefore provides a more sensitive measure of health status.

With expanded use of electronic health records and availability of physical measurements, such as systolic blood pressure, BMI, micro-albuminuria, and cardiac function studies, which are other factors contemplated to be added to the linear predictors employed in this study, we believe the relationship between ICSs and reimbursement can be further improved.

FIG. 10 demonstrated the potential for ICS values to illustrate changes in objective blood tests results after treatment. When the patient pool was sorted by improved, same, or worse ending ICSs, there were significant changes observed in both the improved and worse ending ICS values (P values=0.00 and 0.00). In addition, the difference in reimbursements between the ICS worse ending group compared to the same ending group, or the better ending compared to same ending group demonstrated slightly significant differences at P values=0.05 and 0.07 respectively. As expected, patients within the worse ending ICS group demonstrated the highest average expenditures.

FIG. 11, in contrast, demonstrated that when the population is sorted by changes in CKD stage from start to end of the study period, a paired T-Test demonstrated a significant difference in both the worse ending and better ending CKD stage groups (P values=0.00 and 0.00). However, the difference in average monthly reimbursement for all three outcomes groups did not demonstrate a significant difference from the average reimbursement for the same ending stage group (ANOVA P values=0.50 and 0.68). We believe it is difficult to use this measure in determining fair reimbursement based on CKD stage change for individual patients.

Furthermore, division of the patient pool by changes in CKD staging over the entire study period demonstrated that 122 of 177 patients (68.9% of the total population) had no change in stage. In contrast, 30 patients (16.9%) ended the study period with the same starting ICS. Comparing CKD stage improvement to ICS improvement: 25 patients (14.1%) improved their stage, while 61 patients (34.4%) improved their ICS. There were 30 patients (16.9%) with a worse ending CKD stage, and 86 patients (48.5%) with a worse ending ICS. The changes observed in ICS scoring over the entire study period produce a more sensitive measure to change in health status which is more consistent with clinical experience. That is: CKD is a chronic progressive disease generally associated with diminishing health, which must be carefully monitored. The percent shift in worsening health for this study's population, 48.5% for ICS monitoring versus 16.9% for CKD stage monitoring, supports clinical experience. Use of ICS may allow evaluation of the reasons for changes in the score (e.g., improvements resulting from provider selection or treatment choices).

FIG. 12 demonstrated that when the linear regression for the averaged Z-scores for each patient is employed in a linear equation calculation, the resultant summation for each patient demonstrates a reasonable predictive correlation (R²=0.41) with the natural logarithm of average monthly reimbursements.

This was contrasted to results for a linear equation summation for average CKD stages in each patient to the natural logarithm of average monthly reimbursements (FIG. 13). The calculated R² value=0.083.

Summary of Example:

1. An illness complexity score (ICS) derived as the predicted value of the average logarithm of reimbursement from the linear regression on patient age and select serum chemistry values in CKD patients produces a single score that significantly relates reimbursement to illness complexity (R²=0.41, P=0.000).

2. Sorting the same patient population by CKD stage and relating it to the natural logarithm of average monthly reimbursement demonstrated an R² value of 0.083.

3. Sorting the patient population by changes in CKD stage or ICS over the entire study period demonstrated significant differences between the two scoring methods. In the ICS groups, there were significant differences in starting and ending scores as well as moderately significant differences in association to reimbursements. In the group sorted by stage differences there was no significant difference in start to ending stage associated with reimbursement.

Although the present invention has been described with respect to one or more particular embodiments, it will be understood that other embodiments of the present invention may be made without departing from the spirit and scope of the present invention. Hence, the present invention is deemed limited only by the appended claims and the reasonable interpretation thereof.

### REFERENCES

1. Keith D S, Nicholas G A, Gullion C M, et al: Longitudinal follow-up and outcome among a population with chronic kidney disease in a large managed care organization. Arch Intern Med 2004; 164:659-663.
2. Lowrie E G, Lew N L: Death risk in hemodialysis patients: The predictive values of commonly measured variables and an evaluation of death rate differences between facilities. Am J Kidney Dis 1990; 15:458-482.
3. Vanholder R, Massy Z, Argiles A, et al: Chronic kidney disease as a cause of cardiovascular morbidity and mortality. Nephrol Dial Transplant 2005; 20:1048-1056.
4. Moe S, Drueke T, Cunningham J, et al: Definition, evaluation, and classification of renal osteodystrophy: A position statement from Kidney Disease: Improving Global Outcomes (KDIGO). Kidney Int 2006; 69:1945-1953.
5. Block G A, Hulbert-Shearon T E, Levin N W, et al: Association of serum phosphorous and calcium×phosphate product with mortality risk in chronic hemodialysis patients: A national study. Am J Kidney Dis 1998; 31:607-617.
6. Teng M, Wolf M, Ofsthun M N, et al: Activated injectable vitamin D and hemodialysis survival: A historical cohort study. J Am Soc Nephrol 2005; 16:1115-1125.
7. Kamycheva E, Sundsfjord J, Jorde R: Serum parathyroid hormone levels predict coronary heart disease: the Tromso Study. Eur J Cardiovasc Prev Rehabil 2004; 11:69-74.
8. Rostand S G, Drueke T B: Parathyroid hormone, vitamin D, and cardiovascular disease in chronic renal failure. Kidney Int 1999; 56:383-392.
9. Usdin T B, Bonner T I, Harta G, et al: Distribution of parathyroid hormone-2 receptor messenger ribonucleic acid in rat. Endocrinology 1996; 137:4285-4297.
10. Smogorzewski M: PTH, chronic renal failure and myocardium. Miner Electrolyte Metab 1995; 21:55-62.
11. Ogino K, Burkhoff D, Bilezikian J P: The hemodynamic basis for the cardiac effects of parathyroid hormone (PTH) and PTH-related protein. Endocrinology 1995; 136:3024-3030.
12. Schluter K D, Piper H: Trophic effects of catecholamines and parathyroid on adult ventricular cardiomyocytes. Am J Physiol 1992; 263:H1739-H1746.
13. Amann K, Ritz E, Wiest G, et al: A role of parathyroid hormone for the activation of cardiac fibroblasts in uremia. J Am Soc Nephrol 1994; 4:1814-1819.
14. Akmal M, Kasim S E, Soliman A R, et al: Excess parathyroid hormone adversely affects lipid metabolism in chronic renal failure. Kidney Int 1990; 37:854-858.
15. Liang K, Oveisi F, Vaziri N D: Role of secondary hyperparathyroidism in the genesis of hypertriglyceridemia and VLDL receptor deficiency in chronic renal failure. Kidney Int 1998; 53:626-630.
16. Akmal M, Massry S G, Goldstein D A, et al: Role of parathyroid hormone in glucose intolerance of chronic renal failure. J Clin Invest 1985; 75:1037-1044.
17. Fadda G Z, Hajjar S M, Perna A F, et al: On the mechanism of impaired insulin secretion in chronic renal failure. J Clin Invest 1991; 87:255-261.
18. Covic A, Kothawala P, Bernal M, et al: Systematic review of the evidence underlying the association between mineral metabolism disturbances and risk of all-cause mortality and cardiovascular mortality and cardiovascular events in chronic kidney disease. Nephrol Dial Transplant 2009; 24:1506-1523.
19. Bhuriya R, Li S L, Chen S C, et al: Plasma parathyroid hormone level and prevalent cardiovascular disease in CKD stages 3 and 4: An analysis from the kidney early evaluation program (KEEP). Amer J Kidney Disease 2009; 53:S3-S10.
20. Blayney M J, Pisoni R L, Bragg-Gresham J L, et al: High alkaline phosphatase levels in hemodialysis patients are associated with higher risk of hospitalization and death. Kidney International 2008; 74:655-663.
21. Stevinkel P, Heimburger O, Lindholm B, et al: Are there two of malnutrition in chronic renal failure? Evidence for relationships between malnutrition, inflammation and atherosclerosis. Nephrol Dial Transplant 2000; 15:953-960.
22. Kalantar-Zadeh K, Ikizler T, Block G, et al: Malnutrition-inflammation complex syndrome in dialysis patients: causes and consequences. Am J Kidney Dis 2003; 42:864-881.
23. Kaysen G: Biological basis of hypoalbuminemia in ESRD. J Am Soc Nephrol 1998; 9:2368-2376.
24. Chronic Kidney Disease Workgroup: Kidney disease outcomes quality initiative clinical practice guidelines. Am J Kidney Dis 2002; 39:S17-S31.
25. Hallan S, Ritz E, Lydersen S, et al: Combining GFR and albuminuria to classify CKD improves prediction of ESRD. J Am Soc Nephrol 2009; 20:1069-1077.
26. Coresh J, Astor B C, Greene T, et al: Prevalence of chronic kidney disease and decreased kidney function in the adult US population: Third National Health and Nutrition Examination Survey. Am J Kidney Dis 2003; 41:1-12.
27. Couser W: Chronic kidney disease—the promise and the perils: J Am Soc Nephrol 2007; 18:2803-2805.
28. Go A S, Chertow G M, Fan D, et al: Chronic kidney disease and the risks of death, cardiovascular events and hospitalization. N Engl J Med 2004; 351:1296-1305.
29. Asselbergs F W, Diercks G F, Hillege H L, et al: Prevention of renal vascular end stage disease intervention trial investigators: Effects of fosinopril and pravastin on cardiovascular events in subjects with microalbuminuria. Circulation 2004; 110:2809-2816.
30. Salonen T, Piirto J, Reina T, et al: Implications of levels of serum mineral metabolism markers, albumin and C-reactive protein for treatment costs of patients on maintenance dialysis. Nephron Clin Pract 2007; 106:c17-c23.

We claim:

1. A method of determining complexity factors for an illness based on a set of individuals having the illness, comprising the steps of:
measuring the values of a plurality of factors indicative of different health parameters for each individual;
supplying the measured values of each individual and a value of the healthcare cost of corresponding individuals to a computer;
causing the computer to determine a Z-score for each measured value based on a predetermined mean and standard deviation of each factor;
causing the computer to determine an effect of each factor on healthcare cost as a Beta coefficient based on the determined Z-scores and corresponding healthcare costs; and
causing the computer to identify one or more factors as complexity variables based on the effect of each factor on the healthcare cost; and
causing the computer to calculate an illness complexity score (ICS) for each individual using the complexity variables and the determined Beta coefficient corresponding to each complexity variable.

2. The method of claim 1, wherein the illness complexity scores are calculated using the complexity variables (CVₙ) and the determined Beta coefficients (B_{CV}_{ₙ}) according to the equation: ICS=Σ₁ⁿ(CVₙ)(B_{CV}_{ₙ}), where n is the number of complexity variables.

3. The method of claim 1, further comprising the step of causing the computer to associate the calculated ICS for each individual of the set of individuals with the healthcare cost for the corresponding individual.

4. The method of claim 1, further comprising the step of causing the computer to calculate an ICS for a patient having the illness using the complexity variables and the determined Beta coefficient corresponding to each complexity variable.

5. The method of claim 4, further comprising the step of causing the computer to predict a healthcare cost of the patient using the calculated ICS of the patient and the associated ICS and healthcare costs of the set of individuals.

6. The method of claim 4, further comprising the step of causing the computer to predict the likelihood of high-cost hospitalization for the patient.

7. The method of claim 1, wherein the step of causing the computer to determine an effect of each factor is performed using linear regression.

8. The method of claim 1, wherein the step of causing the computer to identify one or more factors as complexity variables is performed using backward selection.

9. The method of claim 1, wherein the supplied cost is the cost of treatment of the individual during a predetermined period of time.

10. The method of claim 9, wherein the value measurements are made more than once during the predetermined period of time.

11. The method of claim 10, wherein each individual's measured values for each factor are averaged before determining the Z-score of the measured values.

12. The method of claim 10, wherein each individual's Z-scores of measured values is averaged for each factor.

13. The method of claim 1, wherein the factors measured to determine an ICS for chronic kidney disease (CKD) comprise: age, CKD stage, phosphate (PO4), parathyroid hormone (PTH), glucose, hemoglobin, bicarbonate, albumin, creatinine, blood urine nitrogen (BUN), potassium, calcium, sodium, alkaline phosphatase (Alk-P), alanine aminotransferase (ALT), white blood cells (WBC), and estimated glomerular filtration rate (eGFR).

14. The method of claim 13, wherein the significant factors identified as complexity variables identified are: age, CKD stage, PO4, hemoglobin, albumin, creatinine, ALT, WBC, and eGFR.
